(19) United States
(12) Patent Application Publication
(10) Pub. No.: US 2010/0158478 A1
(43) Pub. Date: Jun. 24, 2010

(54) LIVING MEMORIAL FOR GRAVE MARKER & METHODS OF OPERATION THEREOF

(76) Inventor: Pedro Gomez, JR., Glendora, CA (US)

Correspondence Address: Loza & Loza LLP, 305 North Second Ave., #127, Upland, CA, 91786, US

(21) Appl. No.: 12/645,441

(22) Filed: Dec. 22, 2009

Related U.S. Application Data
(60) Provisional application No. 61/139,792, filed on Dec. 22, 2008.

(51) Int. Cl. H04N 5/91; E04H 13/00; G05B 19/00

(52) U.S. Cl. 386/83; 52/103; 340/5.6

(57) ABSTRACT

Embodiments of the invention are directed to grave markers incorporating a living memorial and methods of operation thereof. In one embodiment, a grave marker incorporating a living memorial includes a monitor and/or speakers electrically or wirelessly connected to a data storage device which stores a pre-recorded message from a deceased or living person of the deceased to be delivered to the deceased's survivors at a future time following the passing of the deceased. In one embodiment, the grave marker is adapted to enclose the monitor in a first position and to display the monitor in a second position when activated. In another embodiment, the grave marker is a stand-alone unit having the monitor and various other components embedded therein.

### FIELD OF INVENTION

At least one feature pertains to a grave marker incorporating a living memorial and methods of operation thereof.

### BACKGROUND OF INVENTION

Grave markers are commemorative markers typically placed proximate to a burial location of a deceased. Headstones, gravestones, tombstones, footstones, upright monuments, urns, niches, crypts, pedestals, benches, tables, companion markers, half-ledgers, mausoleums, semi-private and private estates, and memorial walls are all examples of grave markers. Graves and any related memorials are a focus for mourning and remembrance. A typical grave marker includes the name of the deceased, the birth and death dates, and often times, an inscription. An inscription is typically an epitaph in praise of the deceased or a quotation from religious text. The names of relatives may be added to a grave marker over the years, so that one marker may chronicle the passing of an entire family spread over decades. Since gravestones and a plot in a cemetery or churchyard cost money, they may also be a symbol of wealth or prominence in some communities.

Modern grave markers may incorporate an image of the deceased. In one example, a granite headstone may include an inscribed likeness of the individual. In another example, the granite headstone may incorporate a picture holder to hold a picture of the deceased. Commemorative images on grave markers may serve as a loving reminder to mourners or to those family members too young to hold memories of the deceased. However, such commemorative images are static in nature and do not serve to deliver a message other than those imagined by the mourner or visitor after reflection of the deceased.

### SUMMARY OF INVENTION

A commemorative marker incorporating a living memorial, comprising: (i) a base housing a plurality of components in electrical or wireless communication with at least a video monitor; (ii) a grave marker having the video monitor embedded therein; and (iii) at least one solar panel embedded within the grave marker about the video monitor, the solar panel adapted to receive sunlight and deliver the resultant electricity to a solar-charged battery wherein power generated from the solar-charged battery supplies power to the plurality of components in electrical or wireless communication with the video monitor is herein disclosed.

In some embodiments, the grave marker is a lid pivotably coupled to the base, the grave marker horizontally-oriented relative to the ground. In other embodiments, the grave marker is vertically-oriented relative to the ground. The plurality of components may include at least one processing circuit adapted to execute one or more instructions to retrieve pre-recorded media and display the media on the monitor. The plurality of components may include a data storage device to store the pre-recorded media comprising audio, visual, interactive, hologram or a combination thereof wherein the pre-recorded media has been recorded onto the data storage device by a person, the pre-recorded media comprising the living memorial.

In some embodiments, the video monitor is a display type comprising one of a cathode ray tube, a liquid crystal display and a plasma display. The video monitor may be adapted to display the pre-recorded media. The commemorative marker may further comprise at least one speaker embedded within the lid, the speakers adapted to project sound from the pre-recorded media. The plurality of components may include an externally-located activation switch to activate the pre-recorded media, the activation switch activated when pressure is applied thereto. Alternatively, the plurality of components may include a wireless sensor to activate the pre-recorded media, the wireless sensor activated by an electronic access key. The plurality of components may include a motion detector wherein, when motion is detected by the motion detector, pre-programmed indicia is displayed on the video monitor. In some embodiments, the video monitor and the solar panel(s) are recessed below a surface of the grave marker and a protective cover is positioned over the video monitor and the solar panel(s), the protective cover allowing visible light to pass therethrough. The commemorative marker may be located in a cemetery wherein the cemetery inters one of humans or animals.

A commemorative marker incorporating a living memorial, comprising: (a) a video monitor embedded within a wall of the commemorative marker; (b) a plurality of components in electrical or wireless communication with at least the video monitor; and (c) a power supply to supply power to the plurality of components in electrical or wireless communication with the video monitor wherein the plurality of components includes (i) at least one processing circuit adapted to execute one or more instructions to retrieve pre-recorded media and display the media on the monitor, and (ii) a data storage device to store the pre-recorded media comprising audio, visual, interactive, hologram or a combination thereof wherein the pre-recorded media has been recorded onto the data storage device by a person, the pre-recorded media comprising the living memorial is herein disclosed.

The video monitor may be a display type comprising one of a cathode ray tube, a liquid crystal display and a plasma display, the video monitor adapted to display the pre-recorded media. In some embodiments, at least one speaker is embedded within the lid, the speakers adapted to project sound from the pre-recorded media. In some embodiments, the plurality of components includes an externally-located activation switch to activate the pre-recorded media, the activation switch activated when pressure is applied thereto. In some embodiments, the plurality of components includes a wireless sensor to activate the pre-recorded media, the wireless sensor activated by an electronic access key. In some embodiments, the plurality of components includes a motion detector wherein, when motion is detected by the motion detector, pre-programmed indicia is displayed on the video monitor.

### BRIEF DESCRIPTION OF THE DRAWINGS

FIG. 1 illustrates a sectional front view of a grave marker casing and lid according to an embodiment of the invention.

FIG. 2 illustrates a sectional left-side view of the commemorative marker with a living memorial according to an embodiment of the invention.

FIG. 3A illustrates a sectional front view of the commemorative marker of FIG. 2 showing the internal components therein.

FIG. 3B illustrates a top sectional view of the commemorative marker of FIG. 3A.

FIG. 4A illustrates a sectional left-side view of the commemorative marker of FIG. 2 showing the components of an elevating system used to control movement of the lid from an open position to a closed position and vice-versa.

FIG. 4B illustrates an exploded view of a pulley system of the elevating system of FIG. 4A.

FIGS. 5A-5B illustrates a sectional left-side view of the commemorative marker of FIG. 2 showing the lid in an open position in two alternative configurations.

FIGS. 6A-6C illustrates a top view, a front view and a left-side view, respectively, of a lid of a commemorative marker according to an embodiment of the invention.

FIGS. 8A-8H illustrate various embodiments in which a living memorial device according to embodiments of the invention may be incorporated into various grave markers.

FIG. 9 illustrates a side view of a commemorative marker according to an alternative embodiment of the invention.

### DETAILED DESCRIPTION

The following detailed description is of the best currently contemplated modes of carrying out the invention. The description is not to be taken in a limiting sense, but is made merely for the purpose of illustrating the general principles of the invention.

Embodiments of the invention are directed to grave markers incorporating a living memorial and methods of operation thereof. In one embodiment, a grave marker incorporating a living memorial includes a monitor and/or speakers electrically or wirelessly connected to a data storage device which stores a pre-recorded message from a deceased or living person of the deceased to be delivered to the deceased's survivors at a future time following the passing of the deceased. In one embodiment, the grave marker is adapted to enclose the monitor in a first position and to display the monitor in a second position when activated. In another embodiment, the grave marker is a stand-alone unit having the monitor and various other components embedded therein.

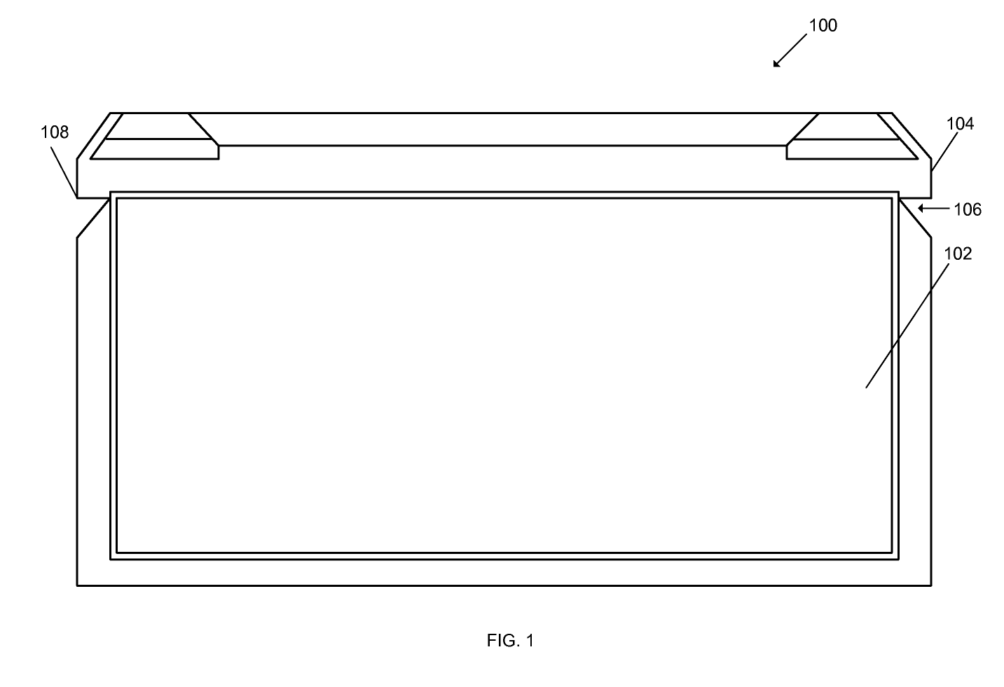

FIG. 1 illustrates a front view of a commemorative marker according to an embodiment of the invention. As shown, commemorative marker 100 includes a housing, or base 102, and a grave marker, or lid 104, pivotably connected thereto. Commemorative marker 100 may be cubical in configuration; however, other geometric configurations are within the scope of the invention. In the embodiment illustrated in FIG. 1, base 102 is hollow and adapted to hold various components comprising a living memorial device (explained in more detail below). Commemorative marker 100 may be made of a material that is able to withstand changes in environmental conditions such as temperature changes (hot and cold), rain, snow, sleet and sunlight. Examples of suitable materials include, but are not limited to, concrete, granite, stone, marble, ceramic, glass or metal in addition to engineered materials such as plastic, polymer resin, fiberglass and other suitable composite materials. Commemorative marker 100 will vary in size depending on client preference and/or local regulations or ordinances. In one embodiment, commemorative marker 100 is approximately twenty-eight (28) inches in width, approximately fifteen and one-half (15½) inches in height, and approximately (16) inches in length. The walls of base 102 may be approximately one inch thick except at a point wherein at least three edges of base 102 meet at least three edges of lid 102. In this respect, the at least three edges of base 102 may be angled such that a gap 106 is formed therebetween to allow lid 104 to be manually lifted from base 102 as necessary (i.e., to perform maintenance on internal components). In this respect, at least three edges of lid 104 form a flange 108 about the least three edges of lid 104.

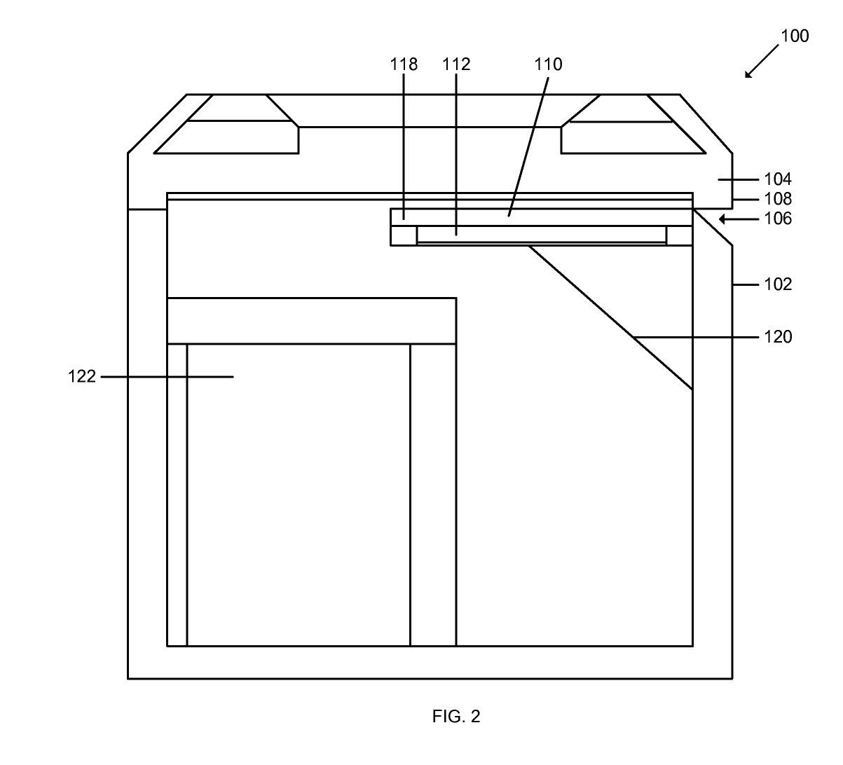

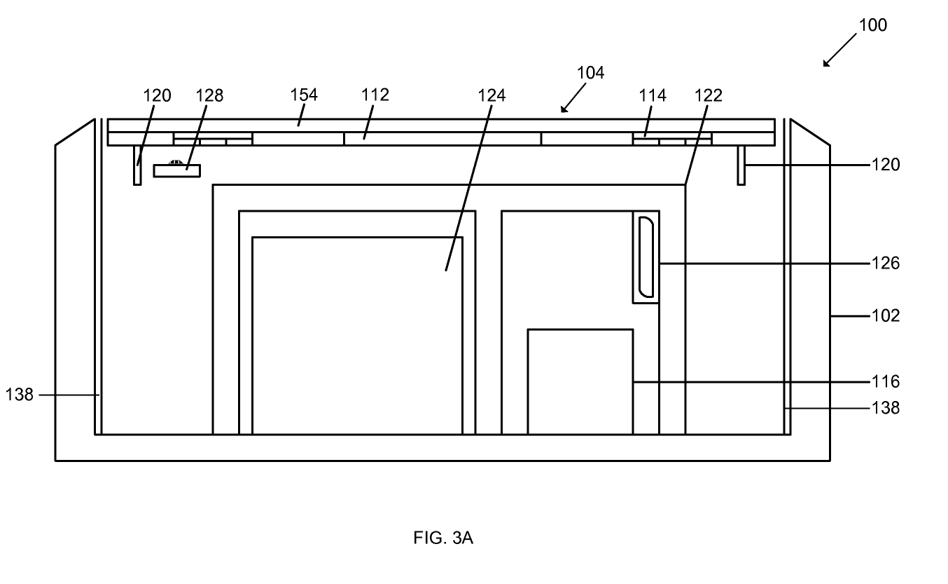

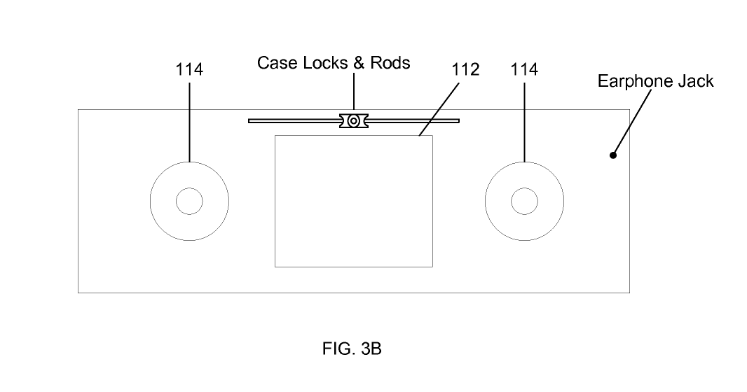

FIG. 2 illustrates a sectional left-side view of commemorative marker 100 illustrated in FIG. 1. As in FIG. 1, sectional views of base 102, lid 104, gap 106 and flange 108 are shown. In one embodiment, base 102 may house a living memorial device 110 which may be comprised of one or more components. In one embodiment, living memorial device 110 includes a video monitor 112 and optionally at least two speakers 114, (not shown, see FIG. 3) electrically or wirelessly connected to, or integral with a data storage device 116 (i.e. a hard drive, not shown, see FIG. 3) which stores pre-recorded media, e.g., “living memorial”, from a deceased to be delivered to the deceased's survivors at a future time following the passing of the deceased. The pre-recorded media may be audio, video, a hologram or a combination thereof. Living memorial device 110 may optionally include a headphone or ear bud jack which overrides default output supply.

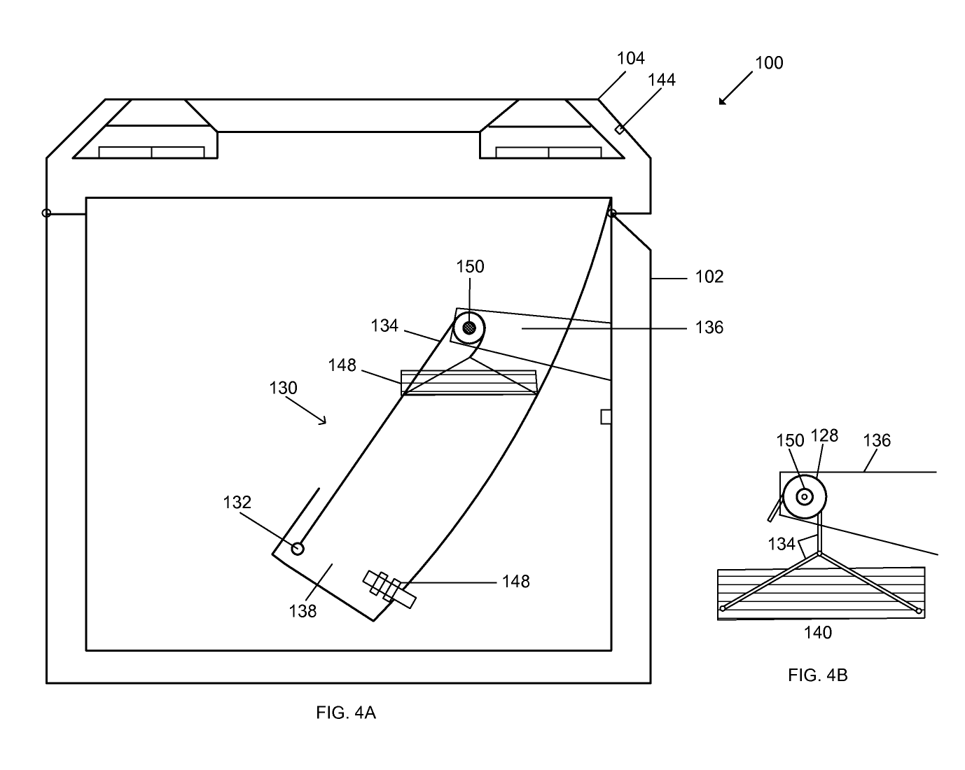

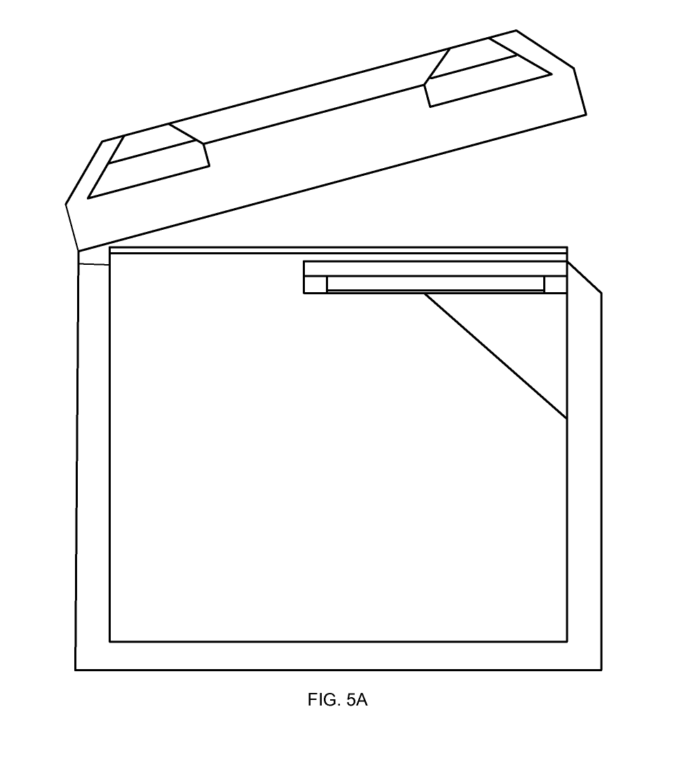

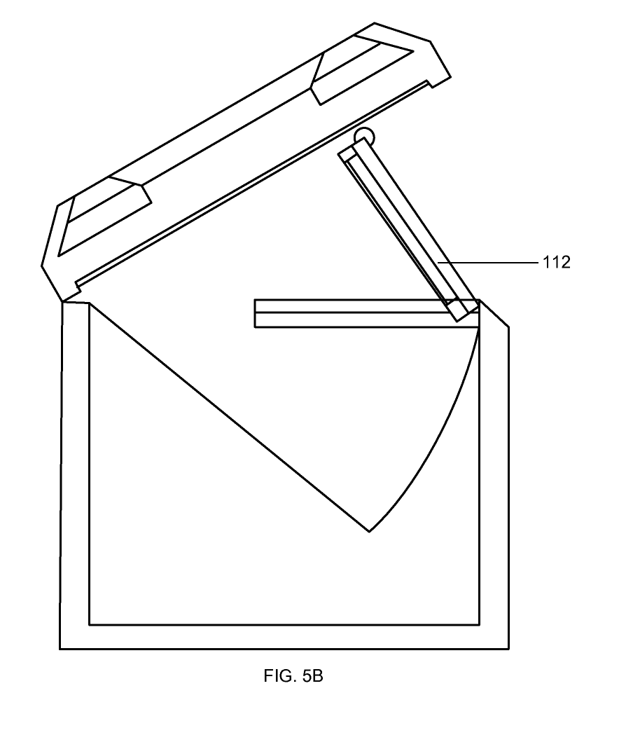

Video monitor 112 may be a display type such as a cathode ray tube, a liquid crystal display or a plasma display. In one embodiment, video monitor 112 is a liquid crystal diode (LCD) or an equivalent thereof. The size of monitor 112 may be sized to fit a particular grave marker, i.e., a headstone, memorial marker, niche/crypt, pedestal, bench/chair memorial, table memorial or mausoleum. For example, in one embodiment, monitor 112 may be an eight (8) inch screen. Monitor 112 is preferably a flat screen. Monitor 112 may be retained by a mounting bracket 118 and held in position by at least two angled brackets 120 (only one bracket 120 shown in this view) on either side thereof. Angled brackets 120 are connected via an approximately six (6) inch aluminum bracket 152 (see FIG. 5B) that connects to the elevating system 130 (see FIGS. 4A-4B) which may be electrically or wirelessly connected to a variable speed bi-directional controller (e.g., 12 v DC motor) for movement of lid 104 from a closed position to an open position. More particularly, the bi-directional controller operates the elevation function of lid support 138 (not shown, see FIG. 4A) which in turn connects to angled brackets 120 of monitor 112 (see FIGS. 5A-5B).

In a closed position, monitor 112 may be positioned horizontally and approximately adjacent to an inside surface of lid 104; however, other suitable positions are within the scope of the invention. In an open position, monitor 112 may be positioned vertically and outside of commemorative marker 100 (explained in more detail below); however, other suitable positions are within the scope of the invention. It should be noted that monitor 112 may be located within the commemorative marker 100 itself or, alternatively, exterior to commemorative marker 100. For example, in the case of commemorative marker 100 being used in conjunction with a mausoleum, it may be appropriate to removably or permanently affix monitor 112 to the exterior of the mausoleum itself (explained in more detail alone).

Base 102 may include an internal casing(s) 122 for housing a power supply 124 (not shown) and data storage device 116 (not shown), e.g., a hard drive. In one embodiment, internal casing 122 is cubicle in configuration; however, other geometric configurations are within the scope of the invention. Internal casing 122 may be made of a suitable material including, but not limited to, concrete, granite, stone, marble, ceramic, glass or metal in addition to engineered materials such as plastic, polymer resin, fiberglass and other suitable composite materials. Internal casing 122 will vary in size depending on client preferences and/or local ordinances or regulations. In one embodiment, internal casing 122 is approximately seven and one-half (7½) inches in width and approximately ten (10) inches in height (see FIG. 2B). The walls of base 102 may be between one-half (½) inches and one inch thick. Internal casing 122 may be positioned at any suitable location within base 102. According to one configuration, internal casing 122 is positioned against a back wall of base 102.

FIG. 3A illustrates a sectional front view of commemorative marker 100 as illustrated in FIG. 2 showing the internal components of internal casing 122. As shown, internal casing 122 houses data storage device 116 and power supply 124 which may be, for example, a 12 v DC solar-charged battery. In one embodiment, a wall within internal casing 122 separates data storage device 116 from power supply 124. A cooling system, such as a fan 126 (e.g., 12 v DC) or equivalent known by one of ordinary skill in the art, may be mounted within internal casing 122 to reduce or prevent overheating of the electrical components of data storage device 116. Also shown are angled brackets 120 that are connected via an approximately six (6) inch aluminum bracket 152 (see FIG. 5B) that connects to the elevating system 130 (see FIGS. 4A-4B) and are in electrical or wireless communication with a motor 128 which, according to one embodiment, controls movement of lid 104 from an open position to a closed position and vice-versa. More particularly, the bi-directional controller operates the elevation function of lid support 138 which in turn connects to angled brackets 120 of monitor 112 (see FIG. 4A-4B). FIG. 3B illustrates a top sectional view of lid 104.

FIG. 4A illustrates a sectional left-side view of commemorative marker 100 as illustrated in FIG. 2 showing the components of an elevating system used to control movement of lid 104 from an open position to a closed position and vice-versa. Lid 104 and monitor 112 are connected on each side by angled brackets 120 which pivot between the lid 104 and monitor 112. Generally, there are three components to commemorative marker 100: (i) lid 104 (motor pulley system raises and lowers lid 104); (ii) monitor 112 (lid 104 in turn raises the monitor 112); and (iii) case 102. Elevating system 130 may include various components to support movement of lid 104 from an open position to a closed position and vice-versa, e.g., pulley system cable mount 132, pulley system cable 134, pulley system support bracket 136, aluminum lid support bracket 138, counter-weight stack 140 and case lid vertical rise locking pin 148 (located on left and right side of lid support bracket 138). FIG. 4B illustrates an exploded view of the pulley system.

FIGS. 5A-5B illustrate sectional left-side views of commemorative marker 100 as illustrated in FIG. 2 showing lid 104 in an open position in two alternative configurations.

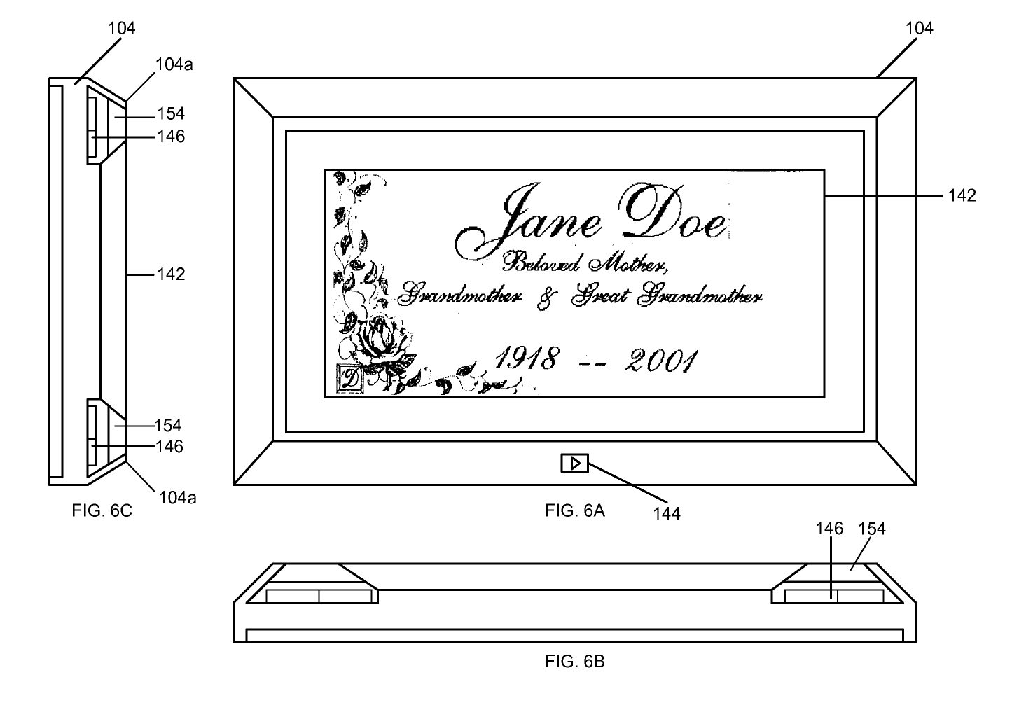

FIGS. 6A-6C illustrate a top view, a front view and a left-side view, respectively, of a grave marker according to an embodiment of the invention. In one embodiment, grave marker 104 includes a center piece 142 centered thereto. Similar to grave marker 104, center piece 142 may be made of material such as granite, marble or other suitable material and known by one of ordinary skill in the art. Center piece 142 preferably includes an inscription, i.e., the name of the deceased, the birth and death dates of the deceased, and optionally an epitaph. Center piece 142 is preferably situated within a depression within lid 104 wherein the depression is sized to accommodate center piece 142 therein (see FIG. 6C). Center piece 142 may be framed or covered by a material which allows visible light to pass therethrough such as polycarbonate (e.g., LEXAN) or an equivalent thereof. In any case, the material framing or covering center piece 142 should preferably be weather-resistant and penetrable by light. Also shown in FIG. 6A is an activation button 144 for activating living memorial device 110 (explained in more detail below).

In FIG. 6B, a plurality of solar panels 146 are shown situated adjacent to center piece 142 with protective covers 154 situated thereover. In one embodiment, solar panels 146 are situated about a periphery of center piece 142 and recessed relative to a top surface of grave marker 104 wherein the recess is sized to accommodate the plurality of solar panels 146. Solar panels 146 can be any of those known by one of ordinary skill in the art. When direct sunlight strikes solar panels 146, energy from the sunlight is converted to power to supply power supply 124 (see FIG. 3) The energy from the solar panels is transferred to the solar battery using a wiring harness commonly used in solar applications and known by one of ordinary skill in the art. Thus, advantageously, commemorative marker 100 can function without a power cord connected to a power outlet. This feature allows commemorative marker 100 to be used in any outdoor environment, e.g., a cemetery, burial grounds or graveyard. FIG. 6C is a left-side view of grave marker 104 of FIGS. 6A-6B. As shown, both center piece 142 and solar panels 146 are situated within a depression within grave marker 104 such that the surfaces of portions of lid grave marker 104, i.e., portions 104a, center piece 142 and solar panels 146 form a horizontal plane.

FIGS. 7A-7C illustrate a top view, a front view and a left-side view, respectively, of a grave marker with a plurality of solar panels 146 positioned thereon according to an embodiment of the invention.

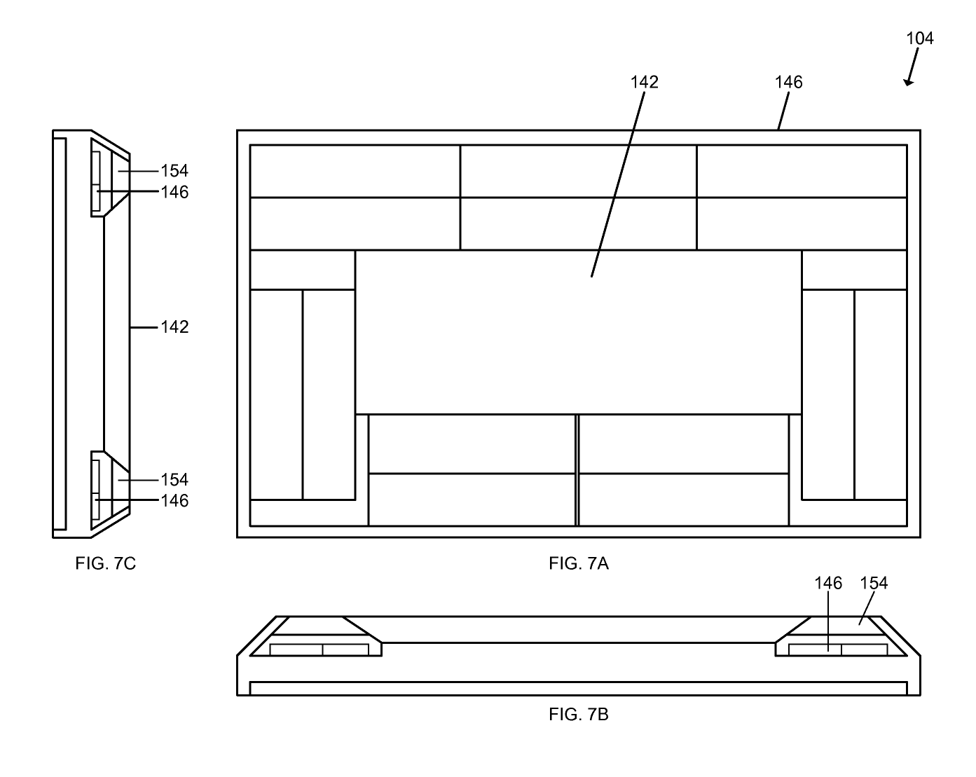

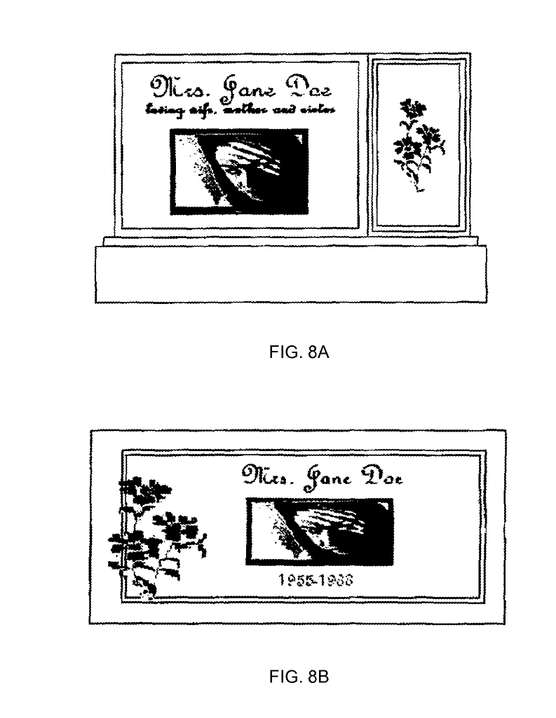

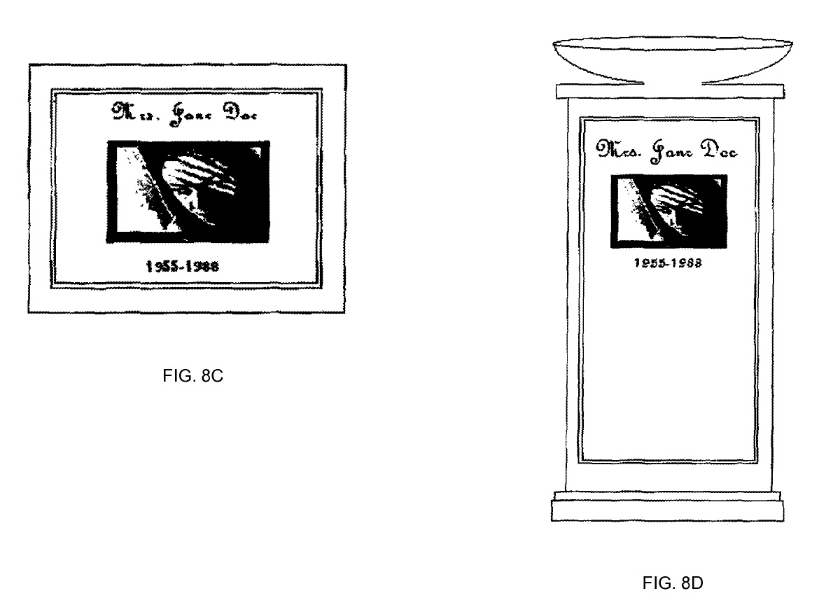

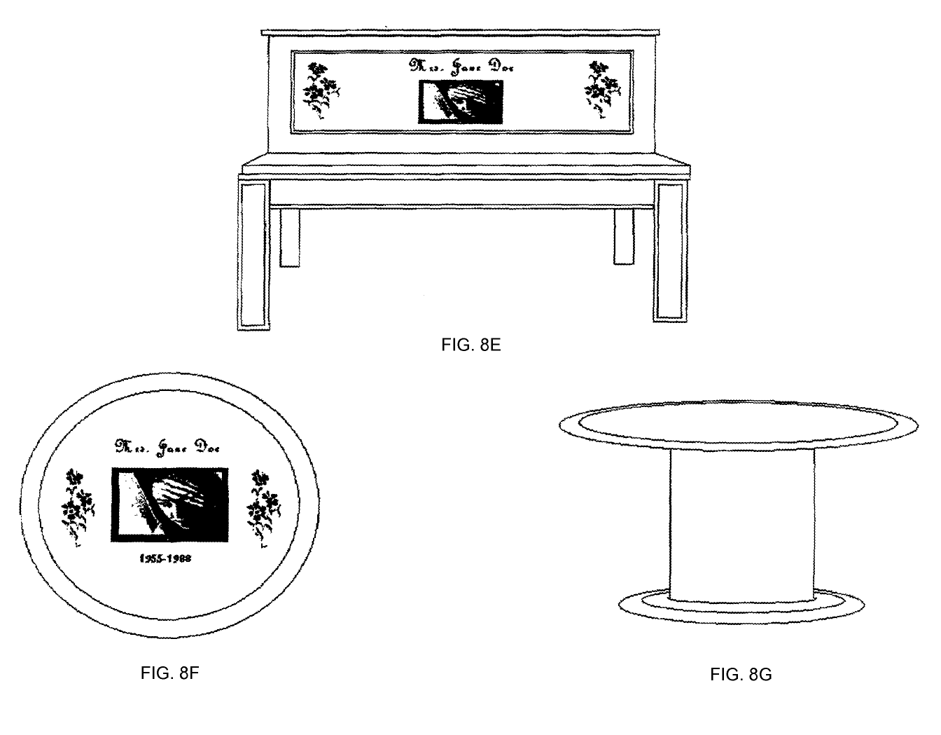

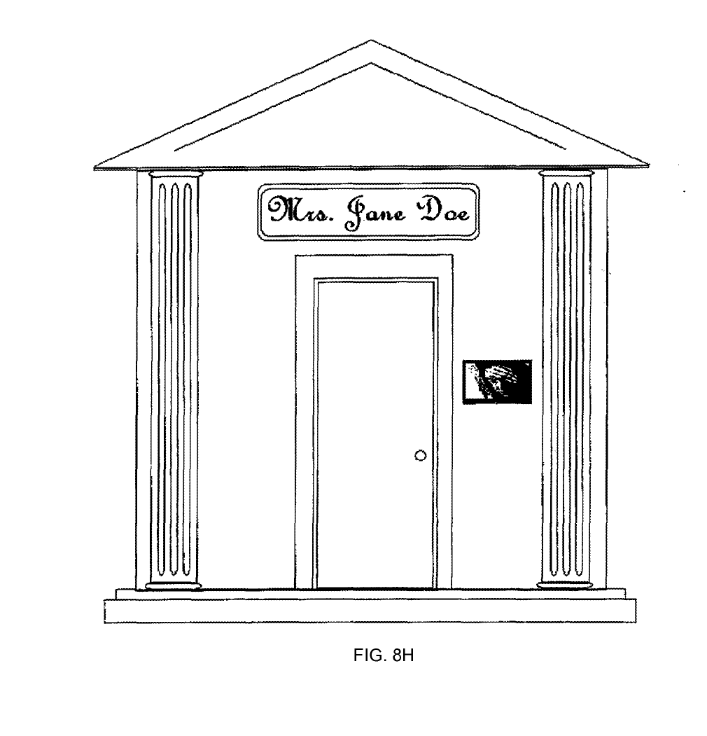

FIGS. 8A-8H illustrate various embodiments in which the living memorial device according to embodiments of the invention as described may be incorporated into various grave markers, e.g., a headstone, memorial marker, niche/crypt, pedestal, bench/chair memorial, table memorial or mausoleum.

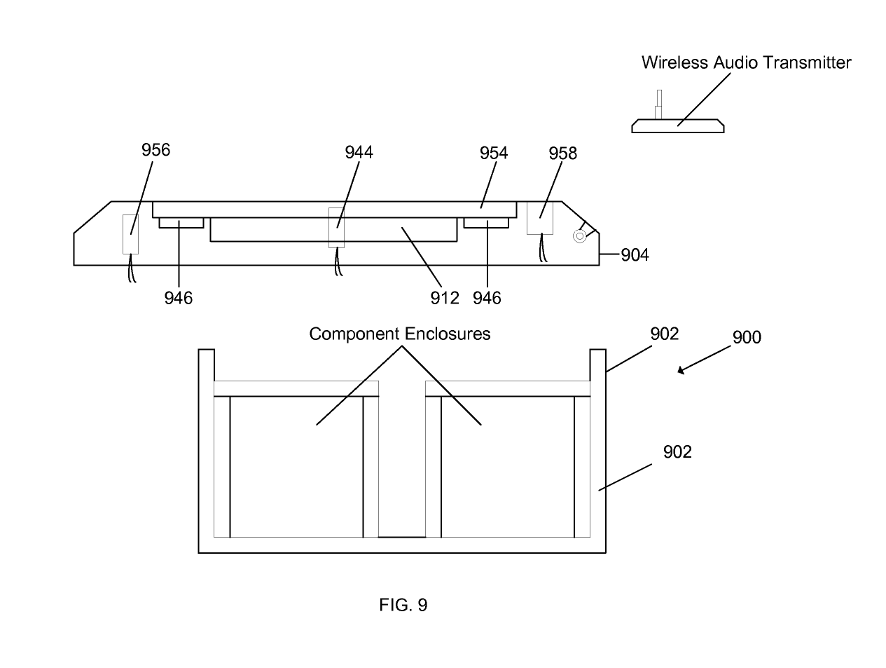

FIG. 9 illustrates a side view of a commemorative marker according to an alternative embodiment of the invention. Similar to the embodiment previously described, commemorative marker 900 includes a housing, or base 902, and a grave marker, or lid 904, pivotably connected thereto. Commemorative marker 900 may have none, some, substantially all or all of the features as described with respect to previous embodiments except that, according to this embodiment, the video monitor 912 is immovable, i.e., embedded within the grave marker 904. In one embodiment, monitor 912 is embedded within a recess of grave marker 904 and approximately centered therein. One or more solar panels 946 may also be positioned within the recess about monitor 946. To protect monitor 912 and solar panels 946, a protective cover 954 (e.g., polycarbonate) may be positioned thereover. Protective cover 954 allows visible light to pass therethrough to allow solar panels 946 to receive sunlight.

Similar to the embodiment previously described, commemorative marker 900 may include an externally-located activation switch 944 to activate the pre-recorded media which activates the “living memorial” when pressure is applied thereto. According to this embodiment, any person may then have access to the “living memorial.” Alternatively, commemorative marker 900 may include a wireless sensor 956 to activate the pre-recorded media which activates the “living memorial” by an electronic access key. According to this embodiment, only persons having possession of the electronic access key would be able to activate the “living memorial” thereby providing a privacy feature to the “living memorial.” In some embodiments, commemorative marker 900 further includes a motion detector 958 to detect motion within a predetermined range. When motion is detected by the motion detector, pre-programmed indicia may be displayed on the video monitor, e.g., a trademark or company logo. It should be appreciated that grave marker 900 may be positioned horizontally or vertically relative to the ground.

According to one method of operation, the living memorial device 110 can be physically activated by depression of activation button 144 (located anywhere on commemorative marker 100, preferably adjacent to the center piece 142, see FIG. 4A). Other methods of activation include, but are not limited to, touch screen, touch sensors, motion sensor, scanners, bar codes, remote activation or any other suitable method known by one of ordinary skill in the art. Upon activation, the “living memorial” sequence will commence as follows: (i) power-up LCD monitor 112; (ii) cue media (video and/or audio) at starting point of media source 116 (may be a removable media card); (iii) power-up cooling fans 126 and power-up 12 v motor 128 for allotted time to raise lid 104 to open position; (iv) play media (video and/or audio) for preset timeline; (v) commence sequence (i)-(iv) in reverse at conclusion of preset timeline and return media (video and/or audio) to the beginning for subsequent activation. In some embodiments, these operations are automatically performed upon receipt of a signal.

The living memorial device 110 may incorporate a program which monitors and ensures the proper function of each program operation and, if a program failure is detected, will reverse the operation resulting in a shut down of the system. If this occurs, the system will be programmed to allow subsequent activation. However, if the program failure persists, a lock-down protocol will commence that will protect the living memorial device 110 from any further damage. If the lock-down protocol is initiated, the system will allow a shut down of the entire operating program and enter into a hibernation mode where it will not allow manual activation for between ten (10) and sixty (60) minutes, preferably, about thirty (30) minutes. After the hibernation mode time is completed, the system will once again allow for manual activation. However, if the program failure continues to persist, the system will shut down permanently until the device 110 can be serviced. In some embodiments, an indicator LED light will flash continuously to indicate that service is required.

According to embodiments of the invention, a living memorial may include a pre-recorded video or audio message stored in data storage device 116 of living memorial device 110. The message may be any message that the deceased wished to pass on to survivors. Advantageously and in view of that the living memorial device 110 is on-site (of the deceased's final resting place), future generations of the deceased are afforded the ability to visit the deceased's grave site and learn details of the deceased from personality traits and life lessons learned, or even knowledge of one's roots and ancestry. Details left behind captured in living memorial 110 are limitless and range from the deceased's favorite foods and music to advice, knowledge and family history. At least one benefit to on-site viewing and/or listening as compared to remote viewing and/or listening is the physical and emotional connection a survivor may feel when in the presence of the deceased's final resting place. Currently available grave markers are static in nature and offer none of the benefits discussed previously and may even leave a survivor feeling more distant to his/her roots and less knowledgeable of his/her past. In some applications, embodiments of the invention may be used for a pet grave.

While certain exemplary embodiments have been described and shown in the accompanying drawings, it is to be understood that such embodiments are merely illustrative of and not restrictive on the broad invention, and that this invention is not to be limited to the specific constructions and arrangements shown and described, since various other modifications may occur to those ordinarily skilled in the art.

What is claimed is:

1. A commemorative marker incorporating a living memorial, comprising:
a base housing a plurality of components in electrical or wireless communication with at least a video monitor;
a grave marker having the video monitor embedded therein; and
at least one solar panel embedded within the grave marker about the video monitor, the solar panel adapted to receive sunlight and deliver the resultant electricity to a solar-charged battery wherein power generated from the solar-charged battery supplies power to the plurality of components in electrical or wireless communication with the video monitor.

2. The commemorative marker of claim 1 wherein the grave marker is a lid pivotably coupled to the base, the grave marker horizontally-oriented relative to the ground.

3. The commemorative marker of claim 1 wherein the grave marker is vertically-oriented relative to the ground.

4. The commemorative marker of claim 1 wherein the plurality of components includes at least one processing circuit adapted to execute one or more instructions to retrieve pre-recorded media and display the media on the monitor.

5. The commemorative marker of claim 4 wherein the plurality of components includes a data storage device to store the pre-recorded media comprising audio, visual, interactive, hologram or a combination thereof wherein the pre-recorded media has been recorded onto the data storage device by a person, the pre-recorded media comprising the living memorial.

6. The commemorative marker of claim 5 wherein the video monitor is a display type comprising one of a cathode ray tube, a liquid crystal display and a plasma display.

7. The commemorative marker of claim 6 wherein the video monitor is adapted to display the pre-recorded media.

8. The commemorative marker of claim 6, further comprising, at least one speaker embedded within the lid, the speakers adapted to project sound from the pre-recorded media.

9. The commemorative marker of claim 5 wherein the plurality of components includes an externally-located activation switch to activate the pre-recorded media, the activation switch activated when pressure is applied thereto.

10. The commemorative marker of claim 5 wherein the plurality of components includes a wireless sensor to activate the pre-recorded media, the wireless sensor activated by an electronic access key.

11. The commemorative marker of claim 1 wherein the plurality of components includes a motion detector wherein, when motion is detected by the motion detector, pre-programmed indicia is displayed on the video monitor.

12. The commemorative marker of claim 1 wherein the video monitor and the at least one solar panel are recessed below a surface of the grave marker, a protective cover positioned over the video monitor and the at least one solar panel, the protective cover allowing visible light to pass therethrough.

13. The commemorative marker of claim 1 wherein the commemorative marker is located in a cemetery.

14. The commemorative marker of claim 13 wherein the cemetery inters one of humans or animals.

15. A commemorative marker incorporating a living memorial, comprising:
a video monitor embedded within a wall of the commemorative marker;
a plurality of components in electrical or wireless communication with at least the video monitor; and
a power supply to supply power to the plurality of components in electrical or wireless communication with the video monitor wherein the plurality of components includes (i) at least one processing circuit adapted to execute one or more instructions to retrieve pre-recorded media and display the media on the monitor, and (ii) a data storage device to store the pre-recorded media comprising audio, visual, interactive, hologram or a combination thereof wherein the pre-recorded media has been recorded onto the data storage device by a person, the pre-recorded media comprising the living memorial.

16. The commemorative marker of claim 15 wherein the video monitor is a display type comprising one of a cathode ray tube, a liquid crystal display and a plasma display, the video monitor adapted to display the pre-recorded media.

17. The commemorative marker of claim 16, further comprising, at least one speaker embedded within the lid, the speakers adapted to project sound from the pre-recorded media.

18. The commemorative marker of claim 15 wherein the plurality of components includes an externally-located activation switch to activate the pre-recorded media, the activation switch activated when pressure is applied thereto.

19. The commemorative marker of claim 15 wherein the plurality of components includes a wireless sensor to activate the pre-recorded media, the wireless sensor activated by an electronic access key.

20. The commemorative marker of claim 15 wherein the plurality of components includes a motion detector wherein, when motion is detected by the motion detector, pre-programmed indicia is displayed on the video monitor.
